(19) United States
(12) Patent Application Publication
(10) Pub. No.: US 2009/0286102 A1
(43) Pub. Date: Nov. 19, 2009

(54) INDUCED CAPILLARY ACTION BRAZING USING METALLIC FOAM MATRIX

(75) Inventors: Mohammad Dzulkifli B Mohyi Hapipi, Singapore (SG); Kin Keong Jek, Singapore (SG); Sor Tin Ng, Singapore (SG)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: TUBINE OVERHAUL SERVICES PTE LTD., Singapore (SG)

(21) Appl. No.: 12/429,352

(22) Filed: Apr. 24, 2009

(30) Foreign Application Priority Data
May 15, 2008 (SG) 2008037376

(51) Int. Cl. B23K 31/02; B32B 5/18

(52) U.S. Cl. 428/613; 228/119

(57) ABSTRACT

A method of repairing a metal component includes affixing a metallic foam matrix to a portion of the component to be repaired, applying a braze alloy over the metallic foam matrix, and heating the component in a substantially oxygen-free atmosphere. Affixing the metallic foam matrix facilitates inducing a capillary action of the braze alloy.

### BACKGROUND

The disclosure relates to methods of processing metal components. In particular, the disclosure relates to methods of brazing gas turbine engine components.

Because of the extreme operating temperatures and mechanical loads encountered during engine operation, many gas turbine engine components, such as turbine vanes and vanes, are fabricated from specialized cast superalloys. Such components are expensive to manufacture, difficult to repair, and are held to strict quality requirements before being put into service in the engine. These components often develop small defects, such as cracks, during manufacturing or during engine operation. Additionally, features of these components, such as cooling holes, pockets, or slots in a turbine vane, may need to be restored after a period of service. Although the defects may be very small, the extreme operating conditions of gas turbine engines may necessitate repairing the defect or scrapping the component.

Many different processes have been developed in an attempt to keep these expensive gas turbine components in service as long as possible. Two processes used to repair gas turbine engine components are fusion welding and brazing. As with many challenges in gas turbine engine design, welding and brazing each have trade-offs that limit their application depending on the type of repair being conducted. Brazing is generally accomplished by flowing a molten braze alloy into the component defect. However, brazing is often ineffective for relatively large defects, because the capillary action induced when the braze alloy is heated to its liquidus state is insufficient to completely fill larger gaps. Welding is generally more appropriate for larger defects, but unfortunately may itself produce additional defects in the component due to the high sensitivity of cast superalloys to cracking. Prior gas turbine engine repairs have therefore failed to provide a process appropriate for repairing relatively large defects, such as cracks, in components fabricated from cast superalloys sensitive to thermally induced stresses.

### SUMMARY

A method of repairing a metal component includes affixing a metallic foam matrix to a portion of the component to be repaired, applying a braze alloy over the metallic foam matrix, and heating the component in a substantially oxygen-free atmosphere. Affixing the metallic foam matrix facilitates inducing a capillary action of the braze alloy.

### BRIEF DESCRIPTION OF THE DRAWINGS

FIG. 1 is a flow chart illustrating a method according to the disclosure of processing a gas turbine engine component.

FIGS. 2A and 2B are images of the microstructure of a slot in an airfoil skin brazed during a trial conducted in accordance with embodiments of the disclosure.

FIGS. 3A and 3B are a plan view and a transverse section view of a gas turbine vane repaired by methods according to the disclosure.

### DETAILED DESCRIPTION

A gas turbine engine component, for example a turbine vane, may develop defects during manufacturing or engine operation or may otherwise necessitate refurbishing a void somewhere on or within the vane. For example, the vane may develop cracks during casting or engine operation or may include holes, slots, pockets, or depressions that need to be refurbished before putting the vane back into service. Embodiments of the disclosure provide methods of processing components that include applying a metallic foam matrix to a repair site to facilitate reducing the effective size of the void to be brazed, which thereby facilitates increasing the relative capillary action induced during brazing. The metallic foam matrix also generally controls flow of the molten braze alloy to facilitate reducing excessive material build-up or material sag caused by external forces, such as gravity.

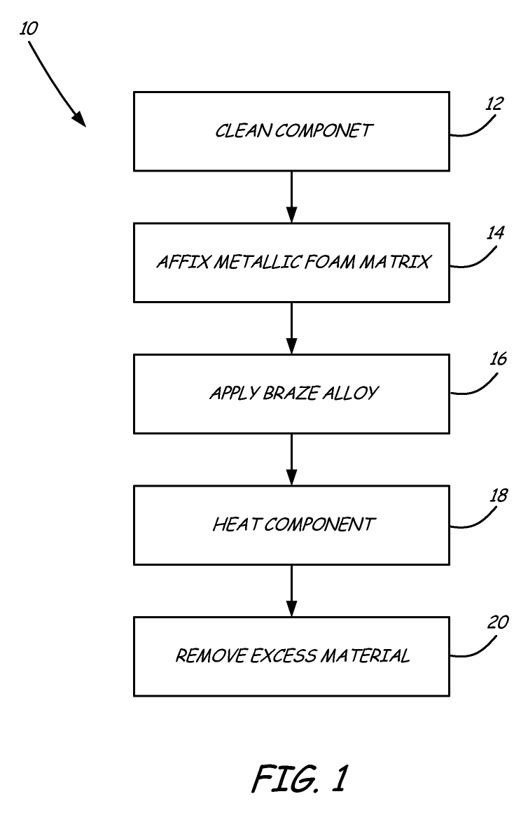

FIG. 1 is a flow chart illustrating method 10 of processing a gas turbine engine component according to the disclosure, which method 10 includes cleaning the component to facilitate reduction of oxide residue (step 12), affixing a metallic foam matrix to a portion of the component to be processed (step 14), applying a braze alloy over the metallic foam matrix (step 16), heating the component in a substantially oxygen-free atmosphere (step 18), and removing excess material from the component (step 20). Cleaning the component (step 12) may include any method known in the art for reducing or substantially removing oxide residue from the surfaces of the component.

During operation, turbine engine components are exposed to extreme temperatures. A component operating at such high temperatures in an oxygen-containing atmosphere develops a layer of oxide residue on the surfaces of the component, including the interior walls of any cracks that may form in the component. Oxide residue effectively functions as a diffusion barrier, which prevents brazing materials from bonding to the walls of the components. Examples of cleaning processes to facilitate removal or reduction of oxide residue include grit blasting, ultrasonic cleaning, power flush cleaning, and hydroflouride (HF) cleaning. One type of HF cleaning appropriate for use in embodiments of the disclosure includes heating the component to temperatures in excess of 1600° F. and exposing the component to a mixture of HF and hydrogen. HF cleaning is effective in penetrating the internal surfaces of the defects in the component and facilitates an increase in wetting of the component material. Increasing the wettability of the component improves brazing by increasing the surface tension of the component and thereby causing the molten braze material to flow on the component surfaces instead of beading.

In addition to cleaning the component to facilitate reduction of oxide residue (step 12), method 10 includes affixing a metallic foam matrix to a portion of the component to be processed (step 14). Affixing a metallic foam matrix to the component (step 14) includes affixing the metallic foam matrix onto a surface of the component including one or more voids and inserting the metallic foam matrix into a void in the component. For example, the metallic foam matrix may be affixed over a film cooling hole in a turbine vane or onto a portion of the airfoil of the vane including one or more cracks. Alternatively, the metallic foam matrix may actually be inserted into a void in the vane, such as inserting the foam matrix into a slot. For example, the foam matrix may be inserted into a feather seal slot in the shroud of turbine vane. The metallic foam matrix may be affixed to the vane by, for example, tack welding the matrix to the vane, or by any other method appropriate for the intended application.

The metallic foam matrix may be, for example, a pad of metallic foam similar in structure to a sponge. More generally, the foam matrix is a lattice of thin metallic members interconnected and convoluted to form a larger structure, e.g. rectangular or other shaped pad, with a substantial amount of free space interspersed throughout the matrix between the thin metallic members. The metallic foam matrix may be fabricated from any material appropriate for processing a particular component. For example, the foam matrix may be fabricated from a superalloy having a composition substantially similar to the turbine vane on which the process is performed. Examples of superalloys used to cast turbine vanes include equiaxial, directionally solidified, and single-crystal nickel alloys. Alternatively, the metallic foam matrix may be fabricated primarily of nickel or cobalt. One metallic foam matrix appropriate for use with embodiments of the disclosure is the nickel based RCM-Ni-4753.016 metallic foam manufactured by Recemat International of Krimpen aan den Ijssel in the Nederlands.

Method 10 also includes applying a braze alloy over the metallic foam matrix (step 16). The braze alloy may be applied over the metallic foam matrix (step 16) in the form of, for example, a powder, a tape, a paint, or a paste. The braze alloy may include any alloy appropriate for use with the intended application, which may vary depending on the type of component and the material from which the component is fabricated. In some embodiments of the disclosure, the braze allow may include a transient liquid phase (TLP) alloy powder, as described in U.S. Pat. No. 4,008,844 by Duvall et al. entitled “Method of Repairing Surface Defects Using Metallic Filler Material.” As described in U.S. Pat. No. 4,008,844, which is incorporated herein by reference, the braze alloy includes a mixture of two metal powders with different compositions. One of the powders in the braze alloy approximates that of the superalloy of the component to be repaired while the other powder (TLP alloy) also approximates the superalloy to be repaired and contains a melting point depressant. The mix of the two powders with a carrier produces a paste-like braze alloy. The melting point depressant used in the braze alloy may be, for example, boron, which is capable of rapid diffusion into superalloys such as those used for turbine vanes and vanes.

In addition to applying a braze alloy over the metallic foam matrix (step 16), method 10 includes heating the component in a substantially oxygen-free atmosphere (step 18). The component being processed is heated in an oxygen-free atmosphere (step 18) to facilitate reducing or preventing oxidation during the heat treatment. In one embodiment of the disclosure, the component may be heated in a vacuum. Heating the component in a substantially oxygen-free atmosphere (step 18) may include, for example, heating the component to a temperature equal to or greater than the melting point of the metallic foam matrix and the melting point of the braze alloy, and less than the melting point of the component. For example, in an embodiment of the disclosure including a braze alloy similar to that described in U.S. Pat. No. 4,008,844, the component may be heated to a temperature at which the boron-containing powder melts, but the boron-free powder and the component base material do not melt. In one embodiment of the disclosure, the component may be heated to between approximately 2100° and 2300° Fahrenheit. In a further embodiment of the disclosure, the component may be heated to between approximately 2200° and 2300° Fahrenheit. Using the two powder mix as the braze alloy allows isothermal solidification at the repair site as the melting point depressant diffuses over a period of time into the base material of the component, thereby raising the solidification temperature of the melted braze alloy.

When the component is heated (step 18), some or all of the braze alloy melts and flows into a void over which the metallic foam matrix is affixed (step 14) and the braze alloy is applied (step 16). Generally speaking, the molten braze alloy is pulled into the void by a capillary action. In the event the void is relatively large, the capillary action may not be sufficient to cause the braze alloy to completely fill the void. However, in embodiments of the disclosure applying the metallic foam matrix to the repair site facilitates reducing the size of the void to be brazed, which thereby facilitates increasing the relative capillary action induced during brazing. Additionally, the metallic foam matrix may generally control flow of the molten braze alloy to facilitate reducing excessive material build-up or material sag caused by external forces, such as gravity.

Several trials were conducted in accordance with embodiments of the disclosure. In one trial, a suction side airfoil skin from a turbine vane was prepared for testing by machining three slots through the airfoil perpendicular to a spanwise edge. The slots were fabricated approximately 1 mm, or 0.04 inches wide to simulate a relatively large void in the airfoil. The airfoil skin was fabricated from a equiaxial nickel alloy having a composition of about 0.15% carbon, 8.4% chromium, 10% cobalt, 1.1% titanium, 0.65% molybdenum, 10% tungsten, 1.4% hafnium, 3.1% tantalum, 5.5% aluminum, and the balance nickel and various impurities. The metallic foam matrix used in the trial was the RCM-Ni-4753.016 metallic foam manufactured by Recemat International of Krimpen aan den Ijssel in the Nederlands, which is a nickel alloy having a composition of less than 1% iron, less than 5% cobalt, and the balance nickel. The trial included a braze alloy with a mixture of two powders, one powder having a composition approximating the base material of the airfoil and the other powder was a TLP alloy (i.e. a mixture of a powder having a composition approximating the base material and boron as a melting point depressant). The braze alloy powder mixture had approximately 60% base material powder and approximately 40% TLP alloy powder. One of the slots was prepared with only the braze alloy, while the other two slots each included the metallic foam matrix inserted into the slot and the braze alloy applied over the foam matrix. Of the two slots including the foam matrix, one was subjected to HF cleaning and the other was not cleaned before brazing. The airfoil skin with the three slots prepared for brazing was heated to a temperature of approximately 2200° F. (±15°) for approximately 15 min in a braze melting cycle and for an additional 10 hours at the same temperature in a diffusion cycle.

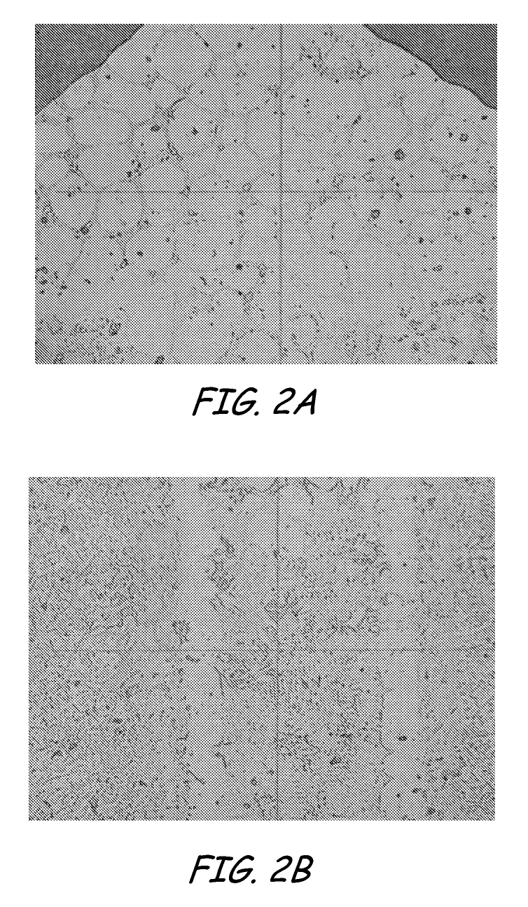

The airfoil skin with the repaired sites, i.e. the brazed slots, was analyzed visually and microscopically to determine the results of the brazing operation. In the slot repaired without using the metallic foam matrix, the braze alloy did not penetrate all the way through the slot. However, the two slots repaired with the foam matrix and braze alloy were completely filled, thereby demonstrating the increase in capillary action induced by the metallic foam matrix. Microstructure analysis was conducted on the slots including the foam matrix. As shown in FIG. 2A, a plate like (round double ring) structure was formed in a matrix near the surface of the slots. However, as shown in FIG. 2B, near the middle of the slot, a needle like structure was formed in a matrix. The plate and needle structures were practically identical in composition, except the center of the plate lacked titanium and seemed to have slightly higher tungsten content. The matrix for both the plate and needle structures was also practically identical in composition. Table 1 shows the results of the microstructure analysis of the brazed slots including the metallic foam matrix.

TABLE 1

| | Metallic | | Surface of Slot | | | | |
|---|---|---|---|---|---|---|---|
| | Foam | Base | Center of | Edge of | | Middle of Slot | |
| | Matrix | Material | Plate | Plate | Matrix | Needles | Matrix |
| Ni | Bal | Bal | Bal | Bal | Bal | Bal | Bal |
| Fe | <1% | — | — | — | — | — | — |
| C | <5% | 0.15% | — | — | — | — | — |
| Cr | — | 8.4% | 8.8% | 8.8% | 9.02% | 8.98% | 8.88% |
| Co | — | 10% | 8.72% | 8.74% | 9.36% | 8.90% | 977% |
| Ti | — | 1.1% | — | 0.59% | 1.03% | 0.67% | 1.09% |
| Mo | — | 0.65% | — | — | — | — | — |
| W | — | 10% | 8.71% | 7.96% | — | 7.4% | — |
| Hf | — | 1.4% | — | — | 3.13% | — | 2.43% |
| Ta | — | 3.1% | — | — | — | — | — |
| Al | — | 5.5% | 3.48% | 3.62% | 3.31% | 3.22% | 2.89% |

As shown in Table 1, the nickel composition of the slots at both the surface and toward the middle was well balanced at about 70% throughout the braze alloy. Additionally, aluminum was well dispersed at about 3+%. HF cleaning did not appear to significantly affect the brazing of the slots in the airfoil skin. The results of the above described trial demonstrate the efficacy of brazing relatively large voids in turbine engine components by affixing a metallic foam matrix over the voids to facilitate increasing the capillary action induced during brazing.

Method 10 also includes removing excess material from the component (step 20). After the component has been heated to fill the void with braze alloy and subsequently cooled, it may be necessary to remove excess material before returning the component to service. For example, material build-up from the repair site, i.e. a combination of the braze alloy and metallic foam matrix, may be removed by milling, grinding, or electrical discharge machining (EDM). Additionally, any other known material removal technique may be employed that is appropriate for the type of component being processed and the material from which the component is fabricated.

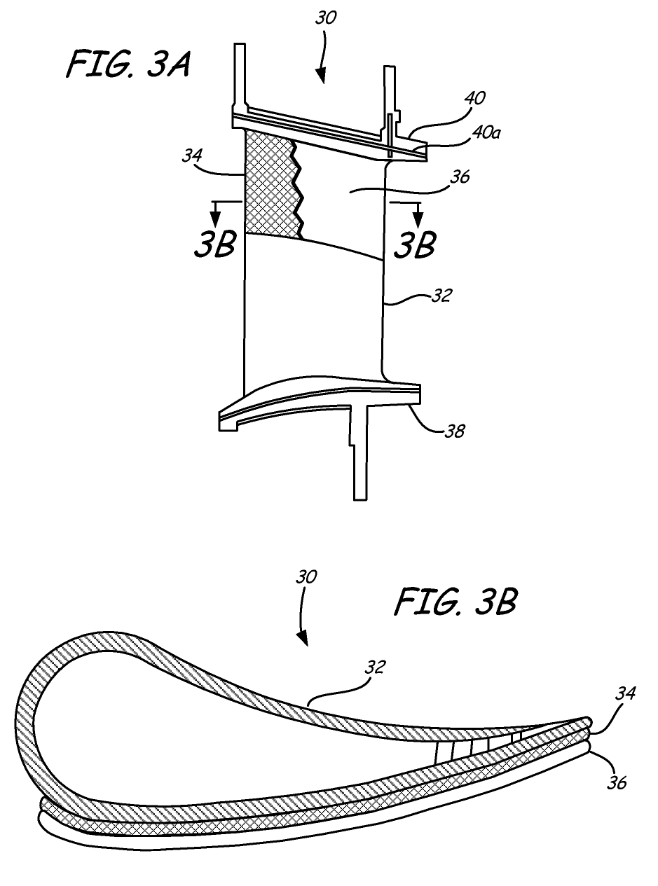

Embodiments according to the disclosure may be used to repair, refurbish, or otherwise process a variety of voids in different types of gas turbine engine components. FIGS. 3A and 3B are a plan view and a transverse section view of gas turbine vane 30 repaired by methods according to the disclosure. Vane 30 includes airfoil 32, metallic foam matrix 34, braze alloy 36, and inner and outer shrouds 38, 40. A method according to the disclosure may be used to braze alloy 36 applied over metallic foam matrix 34 onto the exterior surfaces of airfoil 32 to repair the geometry of airfoil 32, or to fill defects, such as cracks, in airfoil 32. Outer shroud 40 of vane 30 includes slot 40a configured to receive feather seals between adjacent vanes. Feather seal slot 40a may need to be refurbished using a method according to the disclosure to fill in the feather seal slot. For example, metallic foam matrix 34 may be inserted into slot 40a and braze alloy 36 may then be applied over foam matrix 34. In still another embodiment, brazing may be used to fill and refurbish cooling features, such as film cooling holes (not shown), in turbine vane 30.

Methods according to the disclosure have several advantages over prior methods of processing gas turbine engine components. Affixing a metallic foam matrix onto the repair site of the component being repaired facilitates reducing the size of the void onto which the braze alloy is applied. The metallic foam matrix thereby facilitates inducing an increased capillary action to completely fill relatively large voids with the braze alloy. Repairs according to the disclosure therefore facilitate increasing the range of defects that may be repaired and increasing the quality of the repair. The metallic foam matrix also generally controls flow of the molten braze alloy to facilitate reducing excessive material build-up or material sag caused by external forces, such as gravity. In embodiments that employ a braze alloy including a TLP alloy, the metallic foam matrix has the effect of facilitating the reduction of the amount of melting point depressant necessary in the TLP alloy. Facilitating reduction of the concentration of melting point depressant in the braze alloy facilitates increasing diffusion rates into the base material and decreasing the risk of local melting of the base material due to high concentrations of the melting point depressant being diffused locally into the base material.

Although the disclosure has made reference to preferred embodiments, workers skilled in the art will recognize that changes may be made in form and detail without departing from the spirit and scope of the invention.

1. A method of repairing a metal component, the method comprising:
affixing a metallic foam matrix to a portion of the component to be repaired;
applying a braze alloy over the metallic foam matrix; and
heating the component in a substantially oxygen-free atmosphere, wherein affixing the metallic foam matrix facilitates inducing a capillary action of the braze alloy.

2. The method of claim 1 further comprising cleaning the component with a hydroflouride gas to reduce oxide residue on one or more surfaces of the component.

3. The method of claim 1, wherein affixing a metallic foam matrix to a portion of the component comprises affixing the metallic foam matrix on to a surface of the component including one or more voids.

4. The method of claim 3, wherein the one or more voids include at least one of a crack, a depression, a slot, a pocket, and a hole.

5. The method of claim 1, wherein affixing a metallic foam matrix to a portion of the component comprises inserting the metallic foam matrix into a void in the component.

6. The method of claim 5, wherein the void includes at least one of a crack, a slot, a pocket, and a hole.

7. The method of claim 1, wherein the metallic foam matrix comprises one of a nickel alloy and an alloy approximating a composition of the metal component.

8. The method of claim 1, wherein the braze alloy comprises a mixture of a powder having an alloy approximating a composition of the metal component and a powder having the alloy approximating the composition of the metal component and a melting point depressant.

9. The method of claim 8, wherein the melting point depressant is boron.

10. The method of claim 1 further comprising removing excess material from the component after heating the component in a substantially oxygen-free atmosphere.

11. The method of claim 10, wherein the excess material is removed from the component by at least one of milling, grinding, and electrical discharge machining.

12. The method of claim 1, wherein the metallic foam matrix is affixed to the component by tack welding.

13. The method of claim 1, wherein the component is heated to a temperature equal to or greater than a melting point of the metallic foam matrix, greater than a melting point of the braze alloy and less than a melting point of the component.

14. The method of claim 13, wherein the component is heated to a temperature between approximately 2100° F. and 2300° F.

15. The method of claim 14, wherein the component is heated to a temperature between approximately 2200° F. and 2300° F.

16. A repaired gas turbine engine component comprising:
a repair site brazed with a combination of a metallic foam matrix and a braze alloy.

17. The component of claim 16, wherein the repair site is a void defined within the component.

18. The component of claim 17, wherein the metallic foam matrix is affixed within the void, and the braze alloy covers the foam matrix.

19. A gas turbine engine comprising:
a repaired component comprising a repair site brazed with a combination of a metallic foam matrix and a braze alloy.

20. The component of claim 19, wherein the repair site is a void defined within the component and the braze alloy covers the metallic foam matrix.
